(19) United States
(12) Patent Application Publication
(10) Pub. No.: US 2025/0085103 A1
(43) Pub. Date: Mar. 13, 2025

(54) FEATURE CORRELATION

(71) Applicant: QUALCOMM Incorporated, San Diego, CA (US)

(72) Inventors: Kalin Mitkov ATANASSOV, San Diego, CA (US); Daniel Jared SINDER, San Diego, CA (US); Jason CHUNG, San Diego, CA (US)

(21) Appl. No.: 18/464,057

(22) Filed: Sep. 8, 2023

(51) Int. Cl. G01B 11/25; G06T 7/521; G06T 7/70; G06V 10/75; H04N 5/74

(52) U.S. Cl. CPC G01B 11/25; G06T 7/521; G06T 7/70; G06V 10/751; H04N 5/74

(57) ABSTRACT

Systems and techniques are described herein for improved feature correlation. For instance, an apparatus for improved featured correlation is provided. The method may include a projector configured to project a pattern into a scene for feature correlation by an imaging device that captures images of the pattern as projected into the scene; wherein the apparatus is separate from the imaging device.

### TECHNICAL FIELD

The present disclosure generally relates to feature correlation. For example, aspects of the present disclosure include systems and techniques for improving the capability of devices to correlate features captured in images.

### BACKGROUND

A passive stereo-vision system may capture stereoscopically-paired images of a scene using two cameras that are a predetermined distance apart. The passive stereo-vision system may correlate features within the images and determine respective depths to points in the scene represented by the features. For example, the passive stereo-vision system may determine distances to points in the scene based on where the unique features appear in each of the images and the predetermined distance between the cameras.

A six-degree-of-freedom (6DoF) system, according to a visual simultaneous localization and mapping (VSLAM or SLAM) technique, may capture successive images of a scene and track positions of unique features between the successive images. The 6DoF system may assume that the unique features are stationary and may assume that any change in the position of the unique features between the successive images is based on movement or reorientation of the 6DoF system. The 6DoF system may calculate a change in pose of the 6DoF system based on changes in positions of the unique features between the successive images.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for improved feature correlation. According to at least one example, an apparatus for improved feature correlation is provided. The apparatus includes: a projector configured to project a pattern into a scene for feature correlation by an imaging device that captures images of the pattern as projected into the scene; wherein the apparatus is separate from the imaging device.

In another example, a method is provided for improved feature correlation. The method includes: determining to project a pattern into a scene for feature correlation by an imaging device that captures images of the pattern as projected into the scene; and projecting the pattern into the scene from a projector that is separate from the imaging device.

In another example, an apparatus for improved feature correlation is provided that includes at least one memory and at least one processor (e.g., configured in circuitry) coupled to the at least one memory. The at least one processor configured to: determine to project a pattern into a scene for feature correlation by an imaging device that captures images of the pattern as projected into the scene; and project the pattern into the scene from a projector that is separate from the imaging device.

In another example, a non-transitory computer-readable medium is provided that has stored thereon instructions that, when executed by one or more processors, cause the one or more processors to: determine to project a pattern into a scene for feature correlation by an imaging device that captures images of the pattern as projected into the scene; and project the pattern into the scene from a projector that is separate from the imaging device.

In another example, an apparatus for improved feature correlation is provided. The apparatus includes: means for determining to project a pattern into a scene for feature correlation by an imaging device that captures images of the pattern as projected into the scene; and means for projecting the pattern into the scene from a projector that is separate from the imaging device.

In some aspects, one or more of the apparatuses described herein is, can be part of, or can include a mobile device (e.g., a mobile telephone or so-called “smart phone”, a tablet computer, or other type of mobile device), an extended reality (XR) device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1A is a perspective diagram illustrating head-mounted display (HMD), according to various aspects of the present disclosure;

FIG. 1B is a perspective diagram illustrating the head-mounted display (HMD) of FIG. 1A being worn by a user, according to various aspects of the present disclosure;

FIG. 2 is a diagram illustrating an example of an extended reality (XR) system, according to aspects of the disclosure;

FIG. 3 is a block diagram illustrating an architecture of an example XR system, in accordance with some aspects of the disclosure;

FIG. 4 is a block diagram illustrating an architecture of a simultaneous localization and mapping (SLAM) system, according to various aspects of the present disclosure;

FIG. 5 illustrates two images of a scene captured from different camera positions, according to various aspects of the present disclosure;

FIG. 6 illustrates two images and an associated cost function, according to various aspects of the present disclosure;

FIG. 7 is a diagram of an example environment in which systems and techniques may enable pose and/or distance determinations, according to various aspects of the present disclosure;

FIG. 8 illustrates four scenarios in which the projector of FIG. 7 may project adjusted patterns into a scene, according to various aspects of the present disclosure;

FIG. 9 is a block diagram illustrating an example architecture of an example projector, according to various aspects of the present disclosure;

FIG. 10 is a diagram of an example environment in which systems and techniques may enable pose and/or distance determinations, according to various aspects of the present disclosure;

FIG. 11 is a flow diagram illustrating another example process for enabling pose and/or distance determinations, in accordance with aspects of the present disclosure;

FIG. 12 illustrates an aspect of the subject matter in accordance with one aspect.

FIG. 13 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As described above, a passive stereo-vision system may correlate unique features within stereoscopically-paired images of a scene and determine respective depths to points in the scene represented by the unique features based on the positions of the unique features in the stereoscopically-paired images and a distance between the cameras that captured the stereoscopically-paired images. For a passive stereo-vision system to determine the depths to the points in the scene, the points should be represented by visually unique features so that the passive stereo-vision system may correlate the features between the stereoscopically-paired images. A passive stereo-vision system may have difficulty determining a distance between the passive stereo-vision system and an object that lacks visually distinct features. For example, the passive stereo-vision system may have difficulty determining distances between the passive stereo-vision system and points of a blank wall. The blank wall may be visually uniform and may thus lack visually unique features. The passive stereo-vision system may be unable to correlate features of the blank wall between stereoscopically-paired images of the blank wall. Because the passive stereo-vision system is unable to correlate features, the passive stereo-vision system may be unable to determine distances between the passive stereo-vision system and the blank wall.

Visual simultaneous localization and mapping (VSLAM or SLAM) is a computational geometry technique used in devices with cameras, such as robots, extended reality (XR) devices (e.g., head-mounted displays (HMDs)), mobile handsets, autonomous vehicles, among others. In VSLAM, a device can construct and update a map of an unknown environment based on images captured by the device's camera. The device can keep track of the device's pose within the environment (e.g., location and/or orientation) as the device updates the map. For example, the device can be activated in a particular room of a building and can move throughout the interior of the building, capturing images. The device can map the environment, and keep track of its location in the environment, based on tracking where different objects in the environment appear in different images.

Degrees of freedom (DoF) refer to the number of basic ways a rigid object can move through three-dimensional (3D) space. In some cases, six different DoF can be tracked. The six degrees of freedom include three translational degrees of freedom corresponding to translational movement along three perpendicular axes. The three axes can be referred to as x, y, and z axes. The six degrees of freedom include three rotational degrees of freedom corresponding to rotational movement around the three axes, which can be referred to as pitch, yaw, and roll. In the present disclosure, the term “pose” may refer to position (e.g., described with regard to the three translational degrees of freedom) and orientation (e.g., as described with regard to the three rotational degrees of freedom). Thus a pose of an object may refer to the position and orientation of the object according to six degrees of freedom.

In the context of systems that track movement through an environment, such as XR systems and/or VSLAM systems, degrees of freedom can refer to which of the six degrees of freedom the system is capable of tracking. 3DoF systems generally track the three rotational DoF
pitch, yaw, and roll. A 3DoF headset, for instance, can track the user of the headset turning their head left or right, tilting their head up or down, and/or tilting their head to the left or right. 6DoF systems can track the three translational DoF as well as the three rotational DoF. Thus, a 6DoF system can track the user moving forward, backward, laterally, and/or vertically in addition to tracking the three rotational DoF.

A 6DoF system, using a VSLAM technique, may calculate a change in pose of the 6DoF system based on changes in positions of unique features as captured in successive images of a scene. For the 6DoF system to determine changes in its pose, the unique features should be stationary in the scene and should be visually distinct (e.g., such that the 6DoF system may easily recognize the unique features in the successive images despite the unique features changing position between the subsequent images). Similar to the passive stereo-vision system, a 6DoF system may have difficulty determining its pose when a camera of the 6DoF system is facing an object without distinct features (e.g., a blank wall). For example, the blank wall may be visually uniform and may thus lack visually unique features. The 6DoF system may be unable to identify and/or correlate unique features between the successive images. Because the 6DoF system is unable to correlate unique features between successive images, the 6DoF system may be unable to determine its pose based on images of the blank wall.

Systems, apparatuses, methods (also referred to as processes), and computer-readable media (collectively referred to herein as “systems and techniques”) are described herein for enabling pose and/or distance determinations. The systems and techniques described herein may project a pattern (e.g., a unique pattern) into a scene to enable a passive stereo-vision system to correlate the pattern in stereoscopically-paired images of the scene to determine distances between the passive stereo-vision system and points in the scene. Additionally or alternatively, the systems and techniques may project the pattern into a scene to enable a 6DoF system to track the pattern in images of the scene to determine a pose of the 6DoF system relative to the scene.

The systems and techniques may include a projector. The projector may be independent of a passive stereo-vision system and independent of a 6DoF system. For example, the projector may be separate from the passive stereo-vision system and separate from the 6DoF system. Additionally, the projector may project the pattern independent of the passive stereo-vision system and independent of the 6DoF system. For example, the projector may project the pattern into the scene whether a passive stereo-vision system is in the scene or not and/or independent of whether a passive stereo-vision system is capturing stereoscopically-paired images of the pattern or not. Additionally, the projector may project the pattern into the scene whether a 6DoF system is in the scene or not and/or independent of whether a 6DoF system is capturing successive images of the pattern or not.

A passive stereo-vision system may determine distances between points in a scene and the passive stereo-vision system independent of the projector. For example, the passive stereo-vision system may determine distances between the points in the scene and the passive stereo-vision system independent of whether a projector is projecting a pattern into the scene or not. The projector projecting the pattern into the scene may enable the passive stereo-vision system to determine distances between the passive stereo-vision system and points in the scene onto which the pattern is projected more accurately. For example, the projector may project the pattern onto visually indistinct portions of the scene. The passive stereo-vision system may be better able to correlate features in the stereoscopically-paired images of the visually indistinct portions of the scene with the pattern projected thereonto than the passive stereo-vision system would be if the projector did not project the pattern onto the visually indistinct portions of the scene. Further, because the passive stereo-vision system operates independent from the projector, the passive stereo-vision system may determine distances between the points in the scene and the passive stereo-vision system without a priori information regarding the projector and/or the pattern.

Additionally or alternatively, a 6DoF system may determine a pose of the 6DoF system independent of the projector. For example, the 6DoF system may determine the pose of the 6DoF system independent of whether a projector is projecting a pattern into the scene or not. The projector projecting the pattern into the scene may enable the 6DoF system to determine a pose of the 6DoF system more accurately. For example, the projected may project the pattern onto visually indistinct portions of the scene. The 6DoF system may be better able to correlate features in the successive images of the visually indistinct portions of the scene with the pattern projected thereonto than the 6DoF system would be if the projector did not project the pattern onto the visually indistinct portions of the scene. Further, because the 6DoF system operates independent from the projector, the 6DoF system may determine the pose of the 6DoF system without a priori information regarding the projector and/or the pattern.

Further, the projector may be independently steerable relative to a passive stereo-vision system and independently steerable relative to a 6DoF system. For example, the projector may be steered (e.g., pointed) at a point or surface of the scene independent of where the passive stereo-vision system is steered and independent of where the 6DoF system is steered. For example, the projector may be pointed at a visually indistinct portion of a scene (e.g., a blank wall) to project the pattern onto the visually indistinct portion of the scene independent of where the passive stereo-vision system is pointed and/or independent of where the 6DoF system is pointed.

In some aspects, the projector may be stationary in the scene. For example, the projector may be positioned within the scene to remain pointing to a visually indistinct portion of the scene (e.g., a blank wall) to project a pattern onto the visually indistinct portion of the scene. A passive stereo-vision system may move within the scene and determine distances between the passive stereo-vision system and the visually indistinct portion of the scene based on stereoscopically-paired images of the pattern as projected onto the otherwise visually indistinct portion of the scene. Additionally or alternatively, a 6DoF system may move within the scene and determine poses of the 6DoF system based on successive images of the pattern as projected onto the otherwise visually indistinct portion of the scene.

In other aspects, the projector may move within the scene. For example, the projector may move within the scene and may point to one or more visually indistinct portions of the scene (e.g., one or more blank walls) to project a pattern onto the one or more visually indistinct portions of the scene as the projector moves through the scene. A passive stereo-vision system may move within the scene and determine distances between the passive stereo-vision system and the one or more visually indistinct portions of the scene based on stereoscopically-paired images of the pattern as projected onto the otherwise visually indistinct portions of the scene. Additionally or alternatively, a 6DoF system may move within the scene and determine poses of the 6DoF system based on successive images of the pattern as projected onto the otherwise visually indistinct portions of the scene.

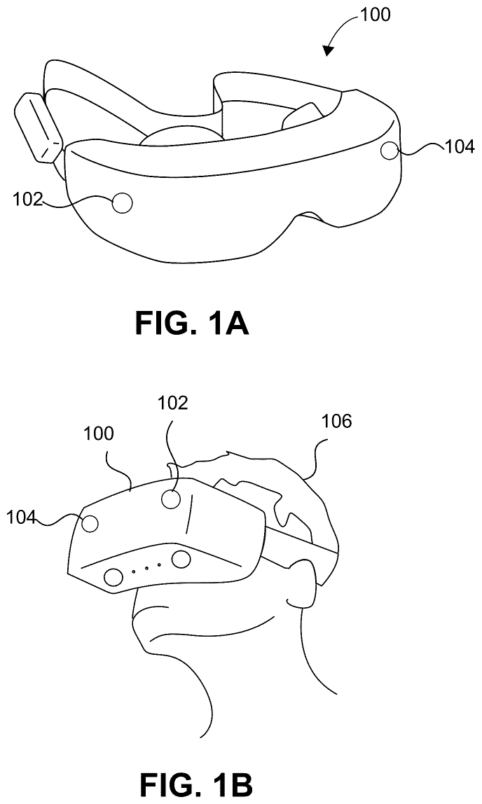

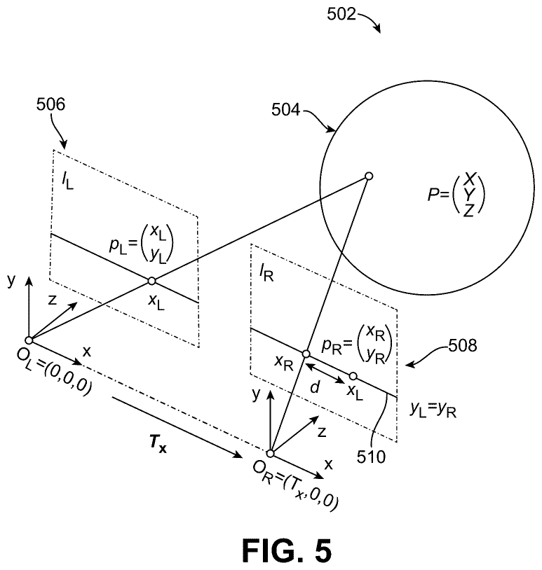

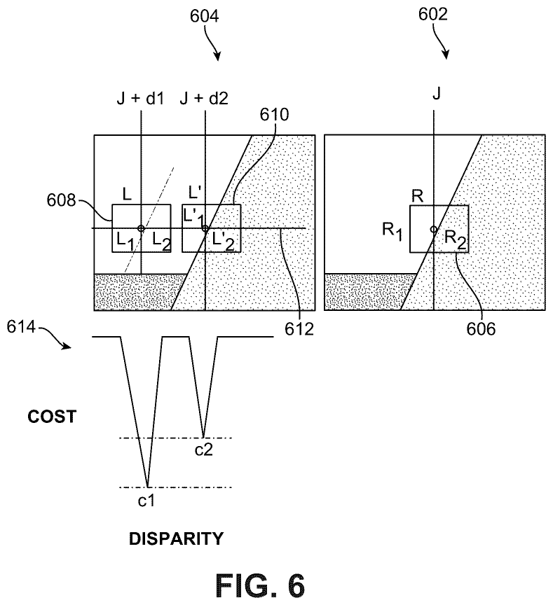

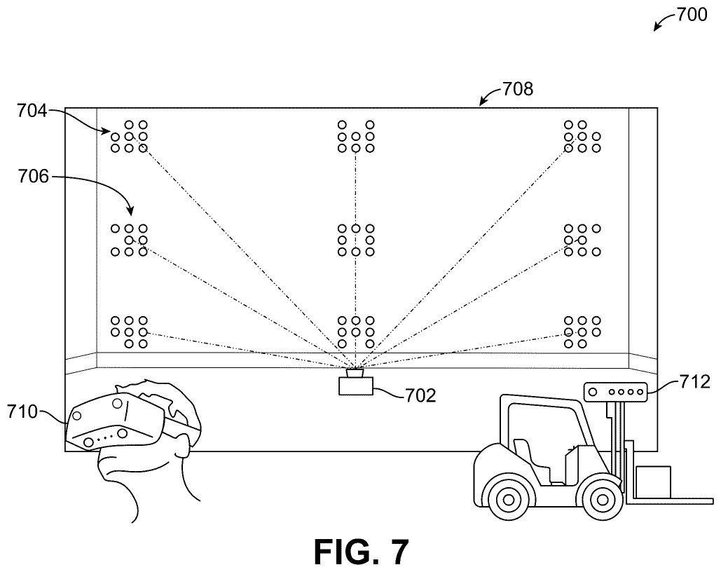

Various aspects of the application will be described with respect to the figures below. For example, FIG. 1A through FIG. 4 (and the corresponding text) provide examples of 6DoF systems and techniques. FIG. 5 and FIG. 6 (and the corresponding text) provide examples of passive stereo-vision techniques. FIG. 7 through FIG. 13 provide examples of systems and techniques for enabling pose and/or distance determinations, according to various aspects of the present disclosure.

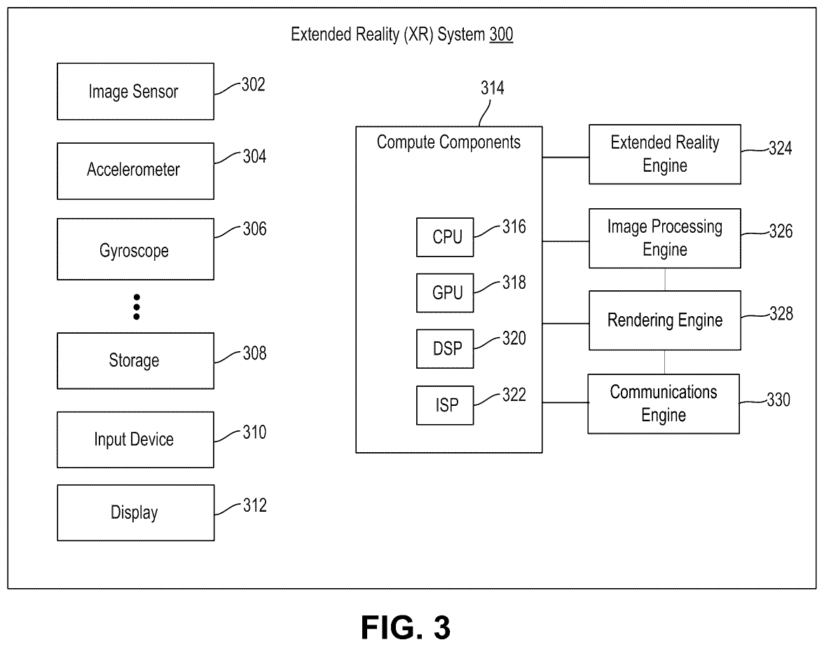

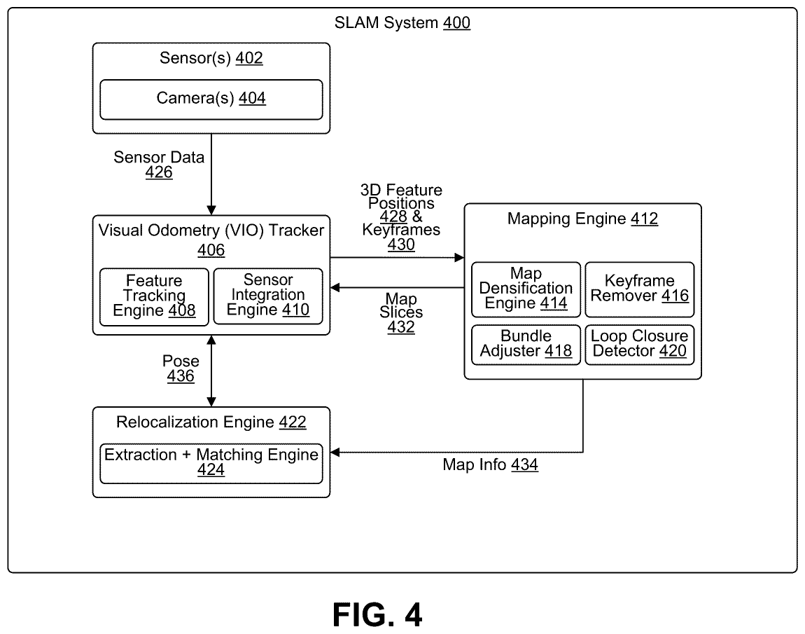

In particular, FIG. 1A is a perspective diagram illustrating head-mounted display (HMD) 100, according to various aspects of the present disclosure. HMD 100 may be, for example, an augmented reality (AR) headset, a virtual reality (VR) headset, a mixed reality (MR) headset, an extended reality (XR) headset, or some combination thereof. HMD 100 may be an example of, or implement, XR system 300 of FIG. 3, SLAM system 400 of FIG. 4, or a combination thereof. HMD 100 includes a first camera 102 and a second camera 104 along a front portion of HMD 100. First camera 102 and second camera 104 may be two of the one or more camera(s) 404 of SLAM system 400 of FIG. 4. In some examples, HMD 100 may only have a single camera. In some examples, HMD 100 may include one or more additional cameras in addition to first camera 102 and second camera 104. In some aspects, HMD 100 may include one or more additional sensors, such as, for example, inertial measurement units (IMUs).

FIG. 1B is a perspective diagram illustrating the head-mounted display (HMD) 100 of FIG. 1A being worn by a user 106, according to various aspects of the present disclosure. User 106 wears HMD 100 on the head of on user 106 over the eyes of user 106. HMD 100 may capture images with first camera 102 and second camera 104. In some examples, HMD 100 may display one or more display images toward the eyes of user 106. The display images may be based on the images captured by first camera 102 and/or second camera 104. The display images may provide a stereoscopic view of the environment, in some cases with information overlaid and/or with other modifications. For example, HMD 100 may display a first display image to the left eye of user 106, the first display image based on an image captured by first camera 102. HMD 100 may display a second display image to the right eye of user 106, the second display image based on an image captured by second camera 104. For instance, HMD 100 may provide overlaid information in the display images overlaid over the images captured by first camera 102 and/or second camera 104.

HMD 100 may determine a pose of HMD 100 and is therefore provided as an example of a 6DoF system. HMD 100 may determine a pose of HMD 100 using visual simultaneous localization and mapping (VSLAM or SLAM) techniques (e.g., based on successive images captured by first camera 102 and/or second camera 104).

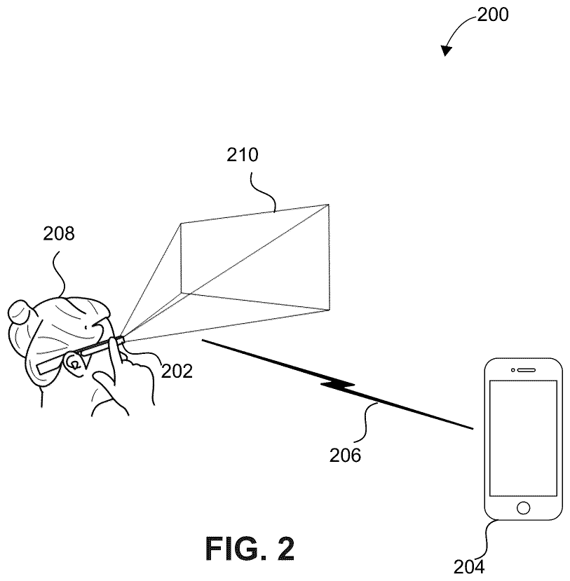

FIG. 2 is a diagram illustrating an example of an extended reality (XR) system 200, according to aspects of the disclosure. XR system 200 may be, for example, an augmented reality (AR) headset, a virtual reality (VR) headset, a mixed reality (MR) headset, an extended reality (XR) headset, or some combination thereof. XR system 200 may be an example of, or implement, XR system 300 of FIG. 3, SLAM system 400 of FIG. 4, or a combination thereof.

As shown, XR system 200 includes an XR device 202, a companion device 204, and a communication link 206 between XR device 202 and companion device 204. In some cases, XR device 202 may generally implement display, image-capture, and/or view-tracking aspects of extended reality, including virtual reality (VR), augmented reality (AR), mixed reality (MR), etc. In some cases, companion device 204 may generally implement computing aspects of extended reality. For example, XR device 202 may capture images of an environment of a user 208 and provide the images to companion device 204 (e.g., via communication link 206). Companion device 204 may render virtual content (e.g., related to the captured images of the environment) and provide the virtual content to XR device 202 (e.g., via communication link 206). XR device 202 may display the virtual content to a user 208 (e.g., within a field of view 210 of user 208).

Generally, XR device 202 may display virtual content to be viewed by a user 208 in field of view 210. In some examples, XR device 202 may include a transparent surface (e.g., optical glass) such that virtual objects may be displayed on (e.g., by being projected onto) the transparent surface to overlay virtual content on real-word objects viewed through the transparent surface (e.g., in a see-through configuration). In some cases, XR device 202 may include a camera and may display both real-world objects (e.g., as frames or images captured by the camera) and virtual objects overlaid on the displayed real-world objects (e.g., in a pass-through configuration). In various examples, XR device 202 may include aspects of a virtual reality headset, smart glasses, a live feed video camera, a GPU, one or more sensors (e.g., such as one or more inertial measurement units (IMUs), image sensors, microphones, etc.), one or more output devices (e.g., such as speakers, display, smart glass, etc.), etc.

Companion device 204 may render the virtual content to be displayed by companion device 204. In some examples, companion device 204 may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Communication link 206 may be a wireless connection according to any suitable wireless protocol, such as, for example, Institute of Electrical and Electronics Engineers (IEEE) 802.11 (Wi-Fi), IEEE 802.15, or Bluetooth™. In some cases, communication link 206 may be a direct wireless connection between XR device 202 and companion device 204. In other cases, communication link 206 may be through one or more intermediary devices, such as, for example, routers or switches and/or across a network.

Similar to HMD 100, XR system 200 (or companion device 204 of XR system 200) may determine a pose of user 208 according to 6 degrees of freedom. Thus, XR system 200 is provided as an example of a 6DoF system. XR system 200 (or companion device 204 of XR system 200) may determine a pose of user 208 using visual simultaneous localization and mapping (VSLAM or SLAM) techniques (e.g., based on successive images captured by one or more cameras of XR device 202).

FIG. 3 is a diagram illustrating an architecture of an example extended reality (XR) system 300, in accordance with some aspects of the disclosure. XR system 300 may execute XR applications and implement XR operations. XR system 300 may be an example of, or may be implemented in, HMD 100 of FIG. 1A and FIG. 1B and/or XR system 200 of FIG. 2.

In this illustrative example, XR system 300 includes one or more image sensors 302, an accelerometer 304, a gyroscope 306, storage 308, an input device 310, a display 312, Compute components 314, an XR engine 324, an image processing engine 326, a rendering engine 328, and a communications engine 330. It should be noted that the components 302-330 shown in FIG. 3 are non-limiting examples provided for illustrative and explanation purposes, and other examples may include more, fewer, or different components than those shown in FIG. 3. For example, in some cases, XR system 300 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 3. While various components of XR system 300, such as image sensor 302, may be referenced in the singular form herein, it should be understood that XR system 300 may include multiple of any component discussed herein (e.g., multiple image sensors 302).

Display 312 may be, or may include, a glass, a screen, a lens, a projector, and/or other display mechanism that allows a user to see the real-world environment and also allows XR content to be overlaid, overlapped, blended with, or otherwise displayed thereon.

XR system 300 may include, or may be in communication with, (wired or wirelessly) an input device 310. Input device 310 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 302 may capture images that may be processed for interpreting gesture commands.

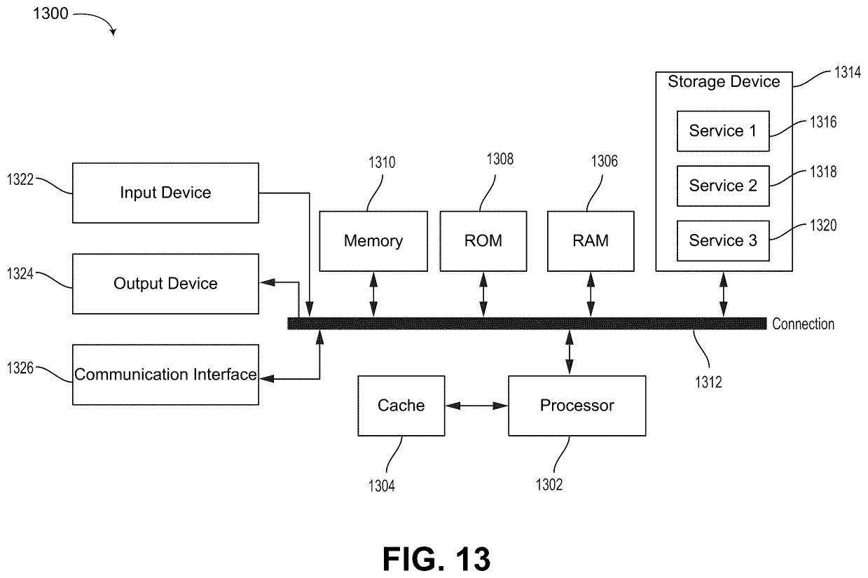

XR system 300 may also communicate with one or more other electronic devices (wired or wirelessly). For example, communications engine 330 may be configured to manage connections and communicate with one or more electronic devices. In some cases, communications engine 330 may correspond to communication interface 1326 of FIG. 13.

In some implementations, image sensors 302, accelerometer 304, gyroscope 306, storage 308, display 312, compute components 314, XR engine 324, image processing engine 326, and rendering engine 328 may be part of the same computing device (such as HMD 100 of FIG. 1A and FIG. 1B). For example, in some cases, image sensors 302, accelerometer 304, gyroscope 306, storage 308, display 312, compute components 314, XR engine 324, image processing engine 326, and rendering engine 328 may be integrated into an HMD, extended reality glasses, smartphone, laptop, tablet computer, gaming system, and/or any other computing device.

In other implementations, image sensors 302, accelerometer 304, gyroscope 306, storage 308, display 312, compute components 314, XR engine 324, image processing engine 326, and rendering engine 328 may be part of two or more separate computing devices. For instance, in some cases, some of the components 302-330 may be part of, or implemented by, one computing device and the remaining components may be part of, or implemented by, one or more other computing devices. For example, such as in a split perception XR system, XR system 300 may include a first device (such as XR device 202 of FIG. 2) including display 312, image sensor 302, accelerometer 304, gyroscope 306, and/or one or more compute components 314. XR system 300 may also include a second device (such as companion device 204 of FIG. 2) including additional compute components 314 (e.g., implementing XR engine 324, image processing engine 326, rendering engine 328, and/or communications engine 330). In such an example, the second device may generate virtual content based on information or data (e.g., images, sensor data such as measurements from accelerometer 304 and gyroscope 306) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 308 may be any storage device(s) for storing data. Moreover, storage 308 may store data from any of the components of XR system 300. For example, storage 308 may store data from image sensor 302 (e.g., image or video data), data from accelerometer 304 (e.g., measurements), data from gyroscope 306 (e.g., measurements), data from compute components 314 (e.g., processing parameters, preferences, virtual content, rendering content, scene maps, tracking and localization data, object detection data, privacy data, XR application data, face recognition data, occlusion data, etc.), data from XR engine 324, data from image processing engine 326, and/or data from rendering engine 328 (e.g., output frames). In some examples, storage 308 may include a buffer for storing frames for processing by compute components 314.

Compute components 314 may be, or may include, a central processing unit (CPU) 316, a graphics processing unit (GPU) 318, a digital signal processor (DSP) 320, an image signal processor (ISP) 322, and/or other processor (e.g., a neural processing unit (NPU) implementing one or more trained neural networks). Compute components 314 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 314 may implement (e.g., control, operate, etc.) XR engine 324, image processing engine 326, and rendering engine 328. In other examples, compute components 314 may also implement one or more other processing engines.

Image sensor 302 may include any image and/or video sensors or capturing devices. In some examples, image sensor 302 may be part of a multiple-camera assembly, such as a dual-camera assembly. Image sensor 302 may capture image and/or video content (e.g., raw image and/or video data), which may then be processed by compute components 314, XR engine 324, image processing engine 326, and/or rendering engine 328 as described herein.

In some examples, image sensor 302 may capture image data and may generate images (also referred to as frames) based on the image data and/or may provide the image data or frames to XR engine 324, image processing engine 326, and/or rendering engine 328 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 302 (and/or other camera of XR system 300) may be configured to also capture depth information. For example, in some implementations, image sensor 302 (and/or other camera) may include an RGB-depth (RGB-D) camera. In some cases, XR system 300 may include one or more depth sensors (not shown) that are separate from image sensor 302 (and/or other camera) and that may capture depth information. For instance, such a depth sensor may obtain depth information independently from image sensor 302. In some examples, a depth sensor may be physically installed in the same general location or position as image sensor 302 but may operate at a different frequency or frame rate from image sensor 302. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 300 may also include other sensors in its one or more sensors. The one or more sensors may include one or more accelerometers (e.g., accelerometer 304), one or more gyroscopes (e.g., gyroscope 306), and/or other sensors. The one or more sensors may provide velocity, orientation, and/or other position-related information to compute components 314. For example, accelerometer 304 may detect acceleration by XR system 300 and may generate acceleration measurements based on the detected acceleration. In some cases, accelerometer 304 may provide one or more translational vectors (e.g., up/down, left/right, forward/back) that may be used for determining a position or pose of XR system 300. Gyroscope 306 may detect and measure the orientation and angular velocity of XR system 300. For example, gyroscope 306 may be used to measure the pitch, roll, and yaw of XR system 300. In some cases, gyroscope 306 may provide one or more rotational vectors (e.g., pitch, yaw, roll). In some examples, image sensor 302 and/or XR engine 324 may use measurements obtained by accelerometer 304 (e.g., one or more translational vectors) and/or gyroscope 306 (e.g., one or more rotational vectors) to calculate the pose of XR system 300. As previously noted, in other examples, XR system 300 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 300, using a combination of one or more accelerometers, one or more gyroscopes, and/or one or more magnetometers. In some examples, the one or more sensors may output measured information associated with the capture of an image captured by image sensor 302 (and/or other camera of XR system 300) and/or depth information obtained using one or more depth sensors of XR system 300.

The output of one or more sensors (e.g., accelerometer 304, gyroscope 306, one or more IMUs, and/or other sensors) can be used by XR engine 324 to determine a pose of XR system 300 (also referred to as the head pose) and/or the pose of image sensor 302 (or other camera of XR system 300). In some cases, the pose of XR system 300 and the pose of image sensor 302 (or other camera) can be the same. The pose of image sensor 302 refers to the position and orientation of image sensor 302 relative to a frame of reference (e.g., with respect to a field of view 210 of FIG. 2). In some implementations, the camera pose can be determined for 6-Degrees of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from image sensor 302 to track a pose (e.g., a 6DoF pose) of XR system 300. For example, the device tracker can fuse visual data (e.g., using a visual tracking solution) from the image data with inertial data from the measurements to determine a position and motion of XR system 300 relative to the physical world (e.g., the scene) and a map of the physical world. As described below, in some examples, when tracking the pose of XR system 300, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 200 within the scene and the 3D map of the scene, etc. The 3D map can provide a digital representation of a scene in the real/physical world. In some examples, the 3D map can anchor position-based objects and/or content to real-world coordinates and/or objects. XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 302 and/or XR system 300 as a whole can be determined and/or tracked by compute components 314 using a visual tracking solution based on images captured by image sensor 302 (and/or other camera of XR system 300). For instance, in some examples, compute components 314 can perform tracking using computer vision-based tracking, model-based tracking, and/or simultaneous localization and mapping (SLAM) techniques. For instance, compute components 314 can perform SLAM or can be in communication (wired or wireless) with a SLAM system (not shown). SLAM refers to a class of techniques where a map of an environment (e.g., a map of an environment being modeled by XR system 300) is created while simultaneously tracking the pose of a camera (e.g., image sensor 302) and/or XR system 300 relative to that map. The map can be referred to as a SLAM map and can be three-dimensional (3D). The SLAM techniques can be performed using color or grayscale image data captured by image sensor 302 (and/or other camera of XR system 300) and can be used to generate estimates of 6DoF pose measurements of image sensor 302 and/or XR system 300. Such a SLAM technique configured to perform 6DoF tracking can be referred to as 6DoF SLAM. In some cases, the output of the one or more sensors (e.g., accelerometer 304, gyroscope 306, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 302 (and/or other camera) to the SLAM map. For example, 6DoF SLAM can use feature point associations from an input image to determine the pose (position and orientation) of the image sensor 302 and/or XR system 300 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 302 and/or the XR system 300 can be determined by projecting features from the 3D SLAM map into an image or video frame and updating the camera pose from verified 2D-3D correspondences.

In one illustrative example, the compute components 314 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 314 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 300 can also track the hand and/or fingers of the user to allow the user to interact with and/or control virtual content in a virtual environment. For example, the XR system 300 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

FIG. 4 is a block diagram illustrating an architecture of a simultaneous localization and mapping (SLAM) system 400. In some examples, the SLAM system 400 can be, or can include, an extended reality (XR) system, such as the XR system 200 of FIG. 2. In some examples, the SLAM system 400 can be a wireless communication device, a mobile device or handset (e.g., a mobile telephone or so-called “smart phone” or other mobile device), a wearable device, a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, an autonomous vehicle, a vehicle, a computing system of a vehicle, a robot, another device, or any combination thereof.

The SLAM system 400 of FIG. 4 includes, or is coupled to, each of one or more sensor(s) 402. The sensor(s) 402 can include one or more camera(s) 404. Each of the camera(s) 404 may include an image capture device, an image processing device, an image capture and processing system, another type of camera, or a combination thereof. Each of the camera(s) 404 may be responsive to light from a particular spectrum of light. The spectrum of light may be a subset of the electromagnetic (EM) spectrum. For example, each of the camera(s) 404 may be a visible light (VL) camera responsive to a VL spectrum, an infrared (IR) camera responsive to an IR spectrum, an ultraviolet (UV) camera responsive to a UV spectrum, a camera responsive to light from another spectrum of light from another portion of the electromagnetic spectrum, or some combination thereof.

The sensor(s) 402 can include one or more other types of sensors other than camera(s) 404, such as one or more of each of: accelerometers, gyroscopes, magnetometers, inertial measurement units (IMUs), altimeters, barometers, thermometers, radio detection and ranging (RADAR) sensors, light detection and ranging (LIDAR) sensors, sound navigation and ranging (SONAR) sensors, sound detection and ranging (SODAR) sensors, global navigation satellite system (GNSS) receivers, global positioning system (GPS) receivers, BeiDou navigation satellite system (BDS) receivers, Galileo receivers, Globalnaya Navigazionnaya Sputnikovaya Sistema (GLONASS) receivers, Navigation Indian Constellation (NavIC) receivers, Quasi-Zenith Satellite System (QZSS) receivers, Wi-Fi positioning system (WPS) receivers, cellular network positioning system receivers, Bluetooth® beacon positioning receivers, short-range wireless beacon positioning receivers, personal area network (PAN) positioning receivers, wide area network (WAN) positioning receivers, wireless local area network (WLAN) positioning receivers, other types of positioning receivers, other types of sensors discussed herein, or combinations thereof. In some examples, the sensor(s) 402 can include any combination of sensors of the XR system 200 of FIG. 2.

The SLAM system 400 of FIG. 4 includes a visual-inertial odometry (VIO) tracker 406. The term visual-inertial odometry may also be referred to herein as visual odometry. The VIO tracker 406 receives sensor data 426 from the sensor(s) 402. For instance, the sensor data 426 can include one or more images captured by the camera(s) 404. The sensor data 426 can include other types of sensor data from the sensor(s) 402, such as data from any of the types of sensors listed herein. For instance, the sensor data 426 can include inertial measurement unit (IMU) data from one or more IMUs of the sensor(s) 402.

Upon receipt of the sensor data 426 from the sensor(s) 402, the VIO tracker 406 performs feature detection, extraction, and/or tracking using a feature tracking engine 408 of the VIO tracker 406. For instance, where the sensor data 426 includes one or more images captured by the camera(s) 404 of the SLAM system 400, the VIO tracker 406 can identify, detect, and/or extract features in each image. Features may include visually distinctive points in an image, such as portions of the image depicting edges and/or corners. The VIO tracker 406 can receive sensor data 426 periodically and/or continually from the sensor(s) 402, for instance by continuing to receive more images from the camera(s) 404 as the camera(s) 404 capture a video, where the images are video frames of the video. The VIO tracker 406 can generate descriptors for the features. Feature descriptors can be generated at least in part by generating a description of the feature as depicted in a local image patch extracted around the feature. In some examples, a feature descriptor can describe a feature as a collection of one or more feature vectors. The VIO tracker 406, in some cases with the mapping engine 412 and/or the relocalization engine 422, can associate the plurality of features with a map of the environment based on such feature descriptors. The feature tracking engine 408 of the VIO tracker 406 can perform feature tracking by recognizing features in each image that the VIO tracker 406 already previously recognized in one or more previous images, in some cases based on identifying features with matching feature descriptors in different images. The feature tracking engine 408 can track changes in one or more positions at which the feature is depicted in each of the different images. For example, the feature extraction engine can detect a particular corner of a room depicted in a left side of a first image captured by a first camera of the camera(s) 404. The feature extraction engine can detect the same feature (e.g., the same particular corner of the same room) depicted in a right side of a second image captured by the first camera. The feature tracking engine 408 can recognize that the features detected in the first image and the second image are two depictions of the same feature (e.g., the same particular corner of the same room), and that the feature appears in two different positions in the two images. The VIO tracker 406 can determine, based on the same feature appearing on the left side of the first image and on the right side of the second image that the first camera has moved, for example if the feature (e.g., the particular corner of the room) depicts a static portion of the environment.

The VIO tracker 406 can include a sensor integration engine 410. The sensor integration engine 410 can use sensor data from other types of sensor(s) 402 (other than the camera(s) 404) to determine information that can be used by the feature tracking engine 408 when performing the feature tracking. For example, the sensor integration engine 410 can receive IMU data (e.g., which can be included as part of the sensor data 426) from an IMU of the sensor(s) 402. The sensor integration engine 410 can determine, based on the IMU data in the sensor data 426, that the SLAM system 400 has rotated 15 degrees in a clockwise direction from acquisition or capture of a first image and capture to acquisition or capture of the second image by a first camera of the camera(s) 404. Based on this determination, the sensor integration engine 410 can identify that a feature depicted at a first position in the first image is expected to appear at a second position in the second image, and that the second position is expected to be located to the left of the first position by a predetermined distance (e.g., a predetermined number of pixels, inches, centimeters, millimeters, or another distance metric). The feature tracking engine 408 can take this expectation into consideration in tracking features between the first image and the second image.

Based on the feature tracking by the feature tracking engine 408 and/or the sensor integration by the sensor integration engine 410, the VIO tracker 406 can determine a 3D feature positions 428 of a particular feature. The 3D feature positions 428 can include one or more 3D feature positions and can also be referred to as 3D feature points. The 3D feature positions 428 can be a set of coordinates along three different axes that are perpendicular to one another, such as an X coordinate along an X axis (e.g., in a horizontal direction), a Y coordinate along a Y axis (e.g., in a vertical direction) that is perpendicular to the X axis, and a Z coordinate along a Z axis (e.g., in a depth direction) that is perpendicular to both the X axis and the Y axis. The VIO tracker 406 can also determine one or more keyframes 430 (referred to hereinafter as keyframes 430) corresponding to the particular feature. A keyframe (from one or more keyframes 430) corresponding to a particular feature may be an image in which the particular feature is clearly depicted. In some examples, a keyframe (from the one or more keyframes 430) corresponding to a particular feature may be an image in which the particular feature is clearly depicted. In some examples, a keyframe corresponding to a particular feature may be an image that reduces uncertainty in the 3D feature positions 428 of the particular feature when considered by the feature tracking engine 408 and/or the sensor integration engine 410 for determination of the 3D feature positions 428. In some examples, a keyframe corresponding to a particular feature also includes data associated with the pose 436 of the SLAM system 400 and/or the camera(s) 404 during capture of the keyframe. In some examples, the VIO tracker 406 can send 3D feature positions 428 and/or keyframes 430 corresponding to one or more features to the mapping engine 412. In some examples, the VIO tracker 406 can receive map slices 432 from the mapping engine 412. The VIO tracker 406 can feature information within the map slices 432 for feature tracking using the feature tracking engine 408.

Based on the feature tracking by the feature tracking engine 408 and/or the sensor integration by the sensor integration engine 410, the VIO tracker 406 can determine a pose 436 of the SLAM system 400 and/or of the camera(s) 404 during capture of each of the images in the sensor data 426. The pose 436 can include a location of the SLAM system 400 and/or of the camera(s) 404 in 3D space, such as a set of coordinates along three different axes that are perpendicular to one another (e.g., an X coordinate, a Y coordinate, and a Z coordinate). The pose 436 can include an orientation of the SLAM system 400 and/or of the camera(s) 404 in 3D space, such as pitch, roll, yaw, or some combination thereof. In some examples, the VIO tracker 406 can send the pose 436 to the relocalization engine 422. In some examples, the VIO tracker 406 can receive the pose 436 from the relocalization engine 422.

The SLAM system 400 also includes a mapping engine 412. The mapping engine 412 generates a 3D map of the environment based on the 3D feature positions 428 and/or the keyframes 430 received from the VIO tracker 406. The mapping engine 412 can include a map densification engine 414, a keyframe remover 416, a bundle adjuster 418, and/or a loop closure detector 420. The map densification engine 414 can perform map densification, in some examples, increase the quantity and/or density of 3D coordinates describing the map geometry. The keyframe remover 416 can remove keyframes, and/or in some cases add keyframes. In some examples, the keyframe remover 416 can remove keyframes 430 corresponding to a region of the map that is to be updated and/or whose corresponding confidence values are low. The bundle adjuster 418 can, in some examples, refine the 3D coordinates describing the scene geometry, parameters of relative motion, and/or optical characteristics of the image sensor used to generate the frames, according to an optimality criterion involving the corresponding image projections of all points. The loop closure detector 420 can recognize when the SLAM system 400 has returned to a previously mapped region and can use such information to update a map slice and/or reduce the uncertainty in certain 3D feature points or other points in the map geometry. The mapping engine 412 can output map slices 432 to the VIO tracker 406. The map slices 432 can represent 3D portions or subsets of the map. The map slices 432 can include map slices 432 that represent new, previously-unmapped areas of the map. The map slices 432 can include map slices 432 that represent updates (or modifications or revisions) to previously-mapped areas of the map. The mapping engine 412 can output map information 434 to the relocalization engine 422. The map information 434 can include at least a portion of the map generated by the mapping engine 412. The map information 434 can include one or more 3D points making up the geometry of the map, such as one or more 3D feature positions 428. The map information 434 can include one or more keyframes 430 corresponding to certain features and certain 3D feature positions 428.

The SLAM system 400 also includes a relocalization engine 422. The relocalization engine 422 can perform relocalization, for instance when the VIO tracker 406 fail to recognize more than a threshold number of features in an image, and/or the VIO tracker 406 loses track of the pose 436 of the SLAM system 400 within the map generated by the mapping engine 412. The relocalization engine 422 can perform relocalization by performing extraction and matching using an extraction and matching engine 424. For instance, the extraction and matching engine 424 can by extract features from an image captured by the camera(s) 404 of the SLAM system 400 while the SLAM system 400 is at a current pose 436 and can match the extracted features to features depicted in different keyframes 430, identified by 3D feature positions 428, and/or identified in the map information 434. By matching these extracted features to the previously-identified features, the relocalization engine 422 can identify that the pose 436 of the SLAM system 400 is a pose 436 at which the previously-identified features are visible to the camera(s) 404 of the SLAM system 400 and is therefore similar to one or more previous poses 436 at which the previously-identified features were visible to the camera(s) 404. In some cases, the relocalization engine 422 can perform relocalization based on wide baseline mapping, or a distance between a current camera position and camera position at which feature was originally captured. The relocalization engine 422 can receive information for the pose 436 from the VIO tracker 406, for instance regarding one or more recent poses of the SLAM system 400 and/or camera(s) 404, which the relocalization engine 422 can base its relocalization determination on. Once the relocalization engine 422 relocates the SLAM system 400 and/or camera(s) 404 and thus determines the pose 436, the relocalization engine 422 can output the pose 436 to the VIO tracker 406.

In some examples, the VIO tracker 406 can modify the image in the sensor data 426 before performing feature detection, extraction, and/or tracking on the modified image. For example, the VIO tracker 406 can rescale and/or resample the image. In some examples, rescaling and/or resampling the image can include downscaling, downsampling, subscaling, and/or subsampling the image one or more times. In some examples, the VIO tracker 406 modifying the image can include converting the image from color to greyscale, or from color to black and white, for instance by desaturating color in the image, stripping out certain color channel(s), decreasing color depth in the image, replacing colors in the image, or a combination thereof. In some examples, the VIO tracker 406 modifying the image can include the VIO tracker 406 masking certain regions of the image. Dynamic objects can include objects that can have a changed appearance between one image and another. For example, dynamic objects can be objects that move within the environment, such as people, vehicles, or animals. A dynamic objects can be an object that have a changing appearance at different times, such as a display screen that may display different things at different times. A dynamic object can be an object that has a changing appearance based on the pose of the camera(s) 404, such as a reflective surface, a prism, or a specular surface that reflects, refracts, and/or scatters light in different ways depending on the position of the camera(s) 404 relative to the dynamic object. The VIO tracker 406 can detect the dynamic objects using facial detection, facial recognition, facial tracking, object detection, object recognition, object tracking, or a combination thereof. The VIO tracker 406 can detect the dynamic objects using one or more artificial intelligence algorithms, one or more trained machine learning models, one or more trained neural networks, or a combination thereof. The VIO tracker 406 can mask one or more dynamic objects in the image by overlaying a mask over an area of the image that includes depiction(s) of the one or more dynamic objects. The mask can be an opaque color, such as black. The area can be a bounding box having a rectangular or other polygonal shape. The area can be determined on a pixel-by-pixel basis.

As noted previously, a passive stereo-vision system may capture stereoscopically-paired images of a scene using two cameras that are a predetermined distance apart. For example, in a passive stereo-vision system, the two cameras may be positioned with different perspectives of the same scene, where each camera may capture an image of the scene at substantially the same time. A system may determine depth information for the scene (e.g., a depth map of scene) based on the images captured by the two cameras, which can be referred to as stereoscopically-paired images. The depth information may include depths of objects in the scene (e.g., distances between the cameras (or a point relative to the cameras) and the objects).

For example, if a scene captured in stereoscopically-paired images includes an object, a pixel in the image from one camera, which represents a point on the object, may have a corresponding pixel in the image from the second camera that represents the same point on the same object. However, because the images are taken by cameras with different perspectives of the same scene, a position of the pixel corresponding to the point on the object in the first image may be different from a position of the pixel corresponding to the same point on the object in the second image. By matching corresponding pixels in the two images and calculating the distance between these corresponding pixels, it is possible to determine a relative depth of the point of objects within the scene. For example, in some cases, the nearer an object is to the cameras, the greater the distance between corresponding pixels within the images.

FIG. 5 illustrates two images, image 506 and image 508 (also denoted in FIG. 5 as image I_{L} and image I_{R}), of a single scene 502 captured from different camera positions, according to various aspects of the present disclosure. The different camera positions are marked as left and right “origin” points, O_{L} and O_{R}, which are offset by a distance Tₓ. Because of the offset Tₓ, the same point P of object 504 appears at different pixel locations p_{L} and p_{R} within the two images 506 (I_{L}) and 508 (I_{R}). As can be seen, the x-axis coordinate x_{R} in image 508 (I_{R}), corresponding to point P_{R} in image 508 (I_{R}), is offset along epi-polar line 510 by disparity d from a coordinate x_{L}, where the coordinate x_{L}, corresponds to the position of the point P in the image 506 (I_{L}). This disparity in pixel locations (also referred to as discrepancy) may be used to determine an approximate distance from the cameras to the point P on object 504 in scene 502. By knowing the stereo camera geometry and applying such an analysis to each point in the images, a depth map of the scene may be generated.

In order to determine the disparity d, a system may determine that the pixel location p_{R} in the image 508 (I_{R}) corresponds to the pixel location p_{L} in the image 506 (I_{L}), for example, by comparing a window of pixels including pixels at, and around, the pixel location p_{L} to a number of windows of pixels in image 508 (I_{R}). An example of such a window-based comparison technique is described with respect to FIG. 6. For example, a passive stereo-vision system may determine epi-polar line 510 in the image 508 (I_{R}). Epi-polar line 510 may be a defined by a ray projected from origin point O_{L} to the point P as viewed in in the image 506 (I_{R}). The passive stereo-vision system may compare the window of pixels including pixels at, and around, the pixel location p_{L} to similarly-sized windows along epi-polar line 510.

FIG. 6 illustrates two images, including image 602 (which may be a “right image” or a “reference image”) and image 604 (which may be a “left image”), and an associated cost function 614, according to various aspects of the present disclosure. To compare windows between image 602 and image 604, a window 606 of pixels from the image 602 may be selected. Window 606 of pixels from image 602 may be compared to one or more windows of pixels from image 604. In some cases, window 606 may be compared to similarly-sized windows (e.g., all similarly-sized windows) along an epi-polar line 612 of image 604.

The cost function 614 shown in FIG. 6 is representative of a similarity between window 606 and similarly-sized windows along epi-polar line 612 of image 604 as a function of disparity. The similarity between windows may be based on similarities between respective red, green, blue, and/or intensity (or brightness or luminance) values of pixels included in the respective windows. The lower the value of cost function 614 for a particular disparity, the higher the degree of similarity is between window 606 and a window of image 602 at the corresponding disparity. For example, cost function 614 includes two minima, c1 and c2. The minima c1 corresponds to a disparity d1, which corresponds to a comparison between window 606 and candidate window 608 of image 604. The minima c2 corresponds to a disparity d2 which corresponds to a comparison between window 606 and candidate window 610 of image 604.

A disparity map may be a two-dimensional map of disparities. The two-dimensional map may relate to an image (e.g., image 506 of FIG. 5). For instance, a two-dimensional disparity map may include a resolution that is the same (or substantially the same in some cases) as a corresponding image, with a respective disparity value for each pixel of the image. In one illustrative example, a disparity map may be generated by determining a respective disparity for each pixel of a number of pixels (e.g., all, or most, of the pixels) of an image (e.g., by scanning windows across epi-polar lines of a stereoscopically-paired image and determining a disparity for each of the number of pixels). Each value of the disparity map may represent a disparity (e.g., disparity d of FIG. 5). A depth map may be derived from a disparity map based on the three-dimensional geometry of a scene (e.g., scene 502 of FIG. 5) including a distance between the cameras which captured the images (e.g., the distance T_{X} of FIG. 5).

A depth map may be a representation of three-dimensional information (e.g., depth information). For example, a depth map may be a two-dimensional map of values (e.g., pixel values) representing depths. The values of the depth map may correspond to pixels in a corresponding image (e.g., image 506 of FIG. 5). For instance, the depth map may have a resolution that is the same or substantially the same as the corresponding image, with each depth value of the depth map representing a depth, or distance, between an origin point (e.g., origin point O_{L} of FIG. 5) and points (e.g., point P of FIG. 5). In some cases, each pixel in the depth map may have one depth value. Because a depth map is based on a disparity map, in some cases, each pixel of a disparity may have one disparity.

A system or device including two camera a known distance apart (e.g., T_{X} of FIG. 5) may implement passive stereo-vision techniques and be a passive stereo-vision system. For example, HMD 100 of FIG. 1A and FIG. 1B includes first camera 102 and user 106 and may be an example of a passive stereo-vision system. Other examples of passive stereo-vision systems include, robots, vehicles, and cameras.

FIG. 7 is a diagram of an example environment 700 in which systems and techniques may enable pose and/or distance determinations, according to various aspects of the present disclosure. For example, a projector 702 may project a pattern 704 into a scene 708 (including onto a surface 706 of scene 708). A 6DoF system 710 may operate in environment 700 and may capture successive images of scene 708. 6DoF system 710 may determine a pose of 6DoF system 710 based on the successive images of scene 708. 6DoF system 710 may be enabled to determine a pose of 6DoF system 710 based on pattern 704 being projected into scene 708. For example, 6DoF system 710 may be able to more accurately and/or more quickly determine the pose of 6DoF system 710 based on successive images of scene 708 including pattern 704 than if the successive images did not include pattern 704. Additionally or alternatively, a passive stereo-vision system 712 may operate in environment 700 and may capture stereoscopically-paired images of scene 708. Passive stereo-vision system 712 may determine distances between passive stereo-vision system 712 and points in scene 708 based on the stereoscopically-paired images. Passive stereo-vision system 712 may be enabled to determine the distances based on pattern 704 being projected into scene 708. For example, passive stereo-vision system 712 may be able to more accurately and/or more quickly determine the distances between passive stereo-vision system 712 and various points of scene 708 based on stereoscopically-paired images of scene 708 including pattern 704 than the stereoscopically-paired images did not include pattern 704.

6DoF system 710 may be any suitable 6DoF system capable of determine a pose of 6DoF system 710 based on successive images of scene 708. 6DoF system 710 may be, or may be included in, as examples, a head-mounted display (e.g., HMD 100 of FIG. 1A and FIG. 1B), an XR system (e.g., XR system 200 of FIG. 2), or a robot.

Passive stereo-vision system 712 may be any suitable passive stereo-vision system capable of determining distances between passive stereo-vision system 712 and respective points of scene 708 based on stereoscopically-paired images of scene 708. Passive stereo-vision system 712 may be, or may be included in, as examples, a head-mounted display (e.g., HMD 100 of FIG. 1A and FIG. 1B), an XR system (e.g., XR system 200 of FIG. 2), a robot, a vehicle, or a camera.

Projector 702 may be a projector or transmitter capable of projecting or transmitting electromagnetic radiation into scene 708 to generate pattern 704. The electromagnetic radiation may be of any suitable wavelength including, as examples, visible light (of any color), near-infrared light, infrared light, or any combination thereof. In some aspects, projector 702 may pattern electromagnetic radiation to generate pattern 704, for example, by projecting light through one or more digital micromirror devices (DMDs) or liquid crystal displays (LCDs). Additionally or alternatively, projector 702 may generate pattern 704 using one or more lasers and/or mirrors. Projector 702 may be, or may include, a digital light processing (DLP) projector, an LCD projector, a light emitting diode (LED) projector, a liquid crystal on silicon (LCOS) projector, and/or a laser projector. In some cases, projector 702 may include a number of projectors, for example, a bundle of projectors. The projectors may be in one location and pointed in the same, or in different directions (e.g., to cover a wider field of view). Additionally or alternatively, the projectors may be in different locations throughout an environment.

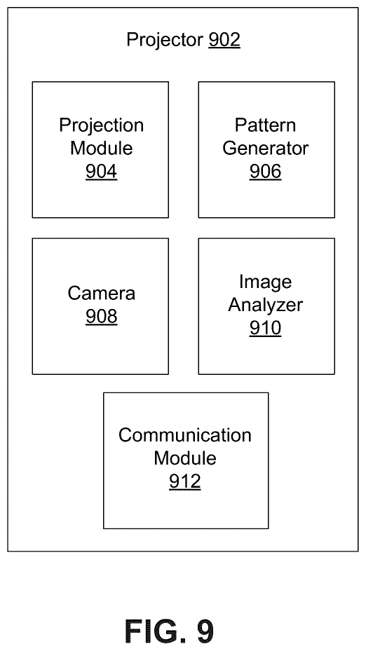

Projector 702 may include a pattern generator (e.g., pattern generator 906 of FIG. 9) that may generate pattern 704 and a projection module (e.g., projection module 904 of FIG. 9) that may project pattern 704 into scene 708. Pattern 704 may include dots or shapes in a unique arrangement. In the present disclosure, the term “unique” may refer to a pattern (or portion of the pattern) being visually unlike other patterns in the scene. “For example, a “unique pattern” may include unique and/or distinctive elements or shapes (such as dots, lines, etc.) that alone or together with the scene content form patches that can be detected and/or matched when compared between images captured by two cameras. Thus, pattern 704 may be unique relative to scene 708. Additionally or alternatively, pattern 704 may include unique portions at various points of scene 708. For example, as illustrated in FIG. 7, pattern 704 may include different unique portions at different points on surface 706. In some aspects, pattern 704 may be composed of dots arranged in one or more patterns. The dots may be of any shape (e.g., circles, squares, triangles, or stars). The dots may all be of the same shape or the dots of pattern 704 may have different shapes. Additionally or alternatively, pattern 704 may include lines (e.g., lines extending across surface 706).

Pattern 704 may be of a uniform color (or wavelength or combination of wavelengths). Alternatively, dots, or portions, of pattern 704, may have different colors (or wavelength or combinations of wavelengths) than other dots or portions. For example, dots on a first side of surface 706 may be of a first color and does on a second side surface 706 may be of a second, different color. Additionally or alternatively, dots on a top side of each group of dots may be of a third color and dots on a bottom side of each group of dots may be of a fourth color.

Pattern 704 may cause surface 706 to appear visually distinct. For example, absent pattern 704, surface 706 may be substantially visually uniform. For example, if 6DoF system 710 were to capture successive images of surface 706 absent pattern 704, 6DoF system 710 may not be able to correctly correlate features of the successive images and 6DoF system 710 may be unable to accurately perform visual simultaneous localization and mapping (VSLAM or SLAM) techniques. However, if 6DoF system 710 were to capture successive images of surface 706 with pattern 704 projected thereonto, 6DoF system 710 may be able to correlate points of the successive images to perform VSLAM techniques. Similarly, if passive stereo-vision system 712 were to capture stereoscopically-paired images of surface 706 absent pattern 704, passive stereo-vision system 712 may not be able to correctly correlate features of the stereoscopically-paired images and passive stereo-vision system 712 may be unable to accurately determine distances to the points of surface 706. However, if passive stereo-vision system 712 were to capture stereoscopically-paired images of surface 706 with pattern 704 projected thereonto, passive stereo-vision system 712 may be able to correlate features of the stereoscopically-paired images to determine depths of the points.

Projector 702 may generate and project pattern 704 onto surface 706 in such a way that pattern 704 is stationary relative to surface 706. Pattern 704 (as projected onto surface 706) may remain constant. The consistency of pattern 704 relative to surface 706 may enable 6DoF system 710 to determine the pose of 6DoF system 710 based on successive images of pattern 704 on surface 706. Additionally or alternatively, the consistency of pattern 704 relative to surface 706 may enable passive stereo-vision system 712 to determine a distance between passive stereo-vision system 712 and points of surface 706.

In some cases, a user may place projector 702 in scene 708 relative to surface 706. For example, the user may position projector 702 to project pattern 704 onto surface 706. Further, the user may adjust pattern 704 based on scene 708 and/or surface 706. For example, the user may adjust an intensity of light of pattern 704, a wavelength of light of 704, a sparsity of dots of pattern 704, sizes of dots of pattern 704, and/or shapes of dots of pattern 704.

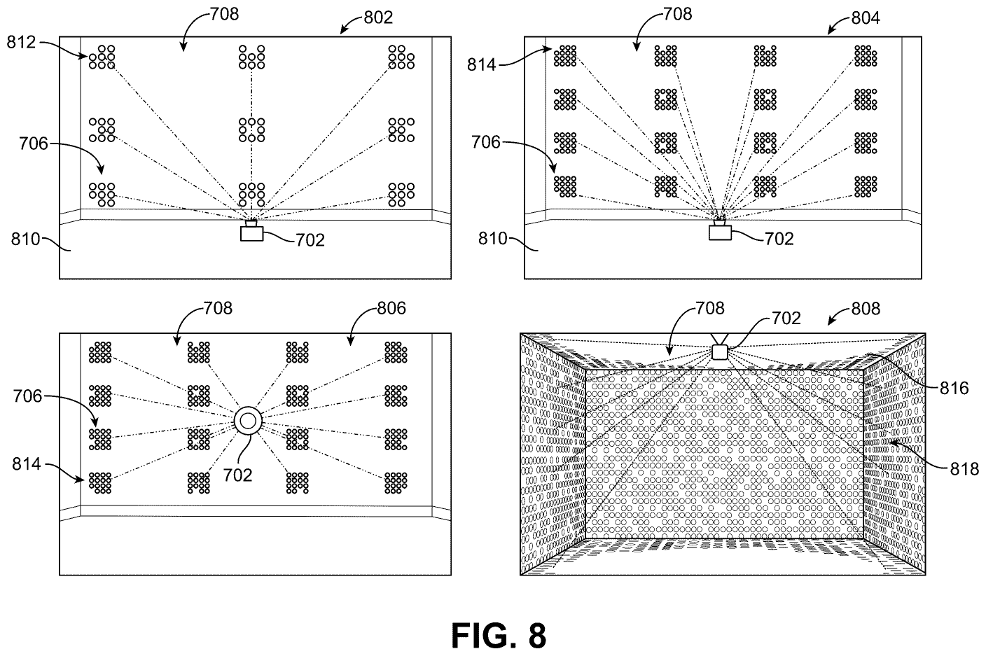

For example, FIG. 8 illustrates four scenarios in which projector 702 may project adjusted patterns 704 into scene 708, according to various aspects of the present disclosure. For example, in a first scenario 802, projector 702 may be positioned on a floor 810 of scene 708 and may project a sparse pattern 812 onto surface 706. In a second scenario 804, projector 702 may be positioned on floor 810 of scene 708 and may project a dense pattern 814 onto surface 706. In a third scenario 806, projector 702 may be positioned on a wall (e.g., surface 706) of scene 708 and may project dense pattern 814 onto surface 706 (albeit from a different angle than the angle from which projector 702 projects dense pattern 814 onto surface 706 in second scenario 804). In a fourth scenario 808, projector 702 may be positioned on a ceiling 816 of scene 708 and may project a very dense pattern 818 onto surface 706 and/or other surfaces of scene 708.

Returning to FIG. 7, in other cases, projector 702 may determine to project pattern 704 into scene 708 and/or onto surface 706. For example, projector 702 may include a camera (e.g., camera 908 of FIG. 9) and an image analyzer (e.g., image analyzer 910 of FIG. 9). Projector 702 may use camera 908 to capture one or more images of scene 708 and determine that surface 706 includes visually indistinct portions. Projector 702 may determine to project pattern 704 onto surface 706 to cause the visually indistinct portions to be visually distinct. For example, projector 702 may capture an image of surface 706 (which may be a blank wall). Projector 702 may identify surface 706 as being visually indistinct within the scene. Projector 702 may determine pattern 704 and may determine to project pattern 704 onto surface 706.

Further, projector 702 may take an image of surface 706 with pattern 704 projected thereonto and determine if pattern 704 causes the visually indistinct portions of surface 706 to be visually distinct. For example, projector 702 may determine if surface 706, with pattern 704 projected thereonto, is visually distinct enough for 6DoF system 710 to determine a pose of 6DoF system 710 and/or for passive stereo-vision system 712 to determine a distance between passive stereo-vision system 712 and surface 706. In some aspects, projector 702 may compare portions (e.g., windows or features) of an image of surface 706 (with pattern 704 projected thereonto) with other portions of the image to determine whether surface 706 (with pattern 704 projected thereonto) is visually distinct enough. If surface 706 (with pattern 704 projected thereonto) is not visually distinct enough, projector 702 may adjust pattern 704 and project the adjusted pattern onto surface 706. Projector 702 may adjust an intensity of light of pattern 704, a wavelength of light of 704, a sparsity of dots of pattern 704, sizes of dots of pattern 704, and/or shapes of dots of pattern 704.

Additionally or alternatively, projector 702 may receive an indication of surface 706 (e.g., an indication that surface 706 is visually indistinct or includes visually indistinct portions) from another system or devices (e.g., using a communication module, such as communication module 912 of FIG. 9). For example, 6DoF system 710 may determine that 6DoF system 710 is having difficulty determining the pose of 6DoF system 710 based on surface 706 and may transmit an indication of such difficulty to projector 702. Additionally or alternatively, passive stereo-vision system 712 may determine that passive stereo-vision system 712 is having difficulty determining distances between passive stereo-vision system 712 and surface 706 and may transmit an indication of such difficulty to projector 702. Projector 702 may project pattern 704 onto surface 706 and/or adjust pattern 704 responsive to such indications.

In some aspects, projector 702 may generate pattern 704 to encode information, such as position information (e.g., coordinates, such as latitude and longitude or local coordinates), time information (e.g., a time of day), or a message (e.g., labels, instructions, and/or warnings). The information may be decoded by image-processing systems. For example, 6DoF system 710 and/or passive stereo-vision system 712 may decode the information. 6DoF system 710 and/or passive stereo-vision system 712 may use the information. For example, a robot may capture an image of surface 706, identify pattern 704, and decode the information encode by pattern 704. The information may include instructions, for example, regarding how to navigate within environment 700. The robot may navigate according to the instructions.

Additionally or alternatively, projector 702 may change the information. For example, if the information is time information, projector 702 may update the time information over time. As another example, if the information is a message, projector 702 may change the message responsive to a user providing a different message.

FIG. 9 is a block diagram illustrating an example architecture of an example projector 902, according to various aspects of the present disclosure. Projector 902 may be an example of projector 702 of FIG. 7 and/or FIG. 8.

Projector 902 includes a projection module 904 that may project a pattern (e.g., a unique pattern into an environment (e.g., onto a surface of the environment). Projector 902 may include one or more light sources (e.g., lamps, bulbs, or lasers), and/or one or more patterning modules (e.g., mirrors or LCDs).

In some aspects, projector 902 may include a pattern generator 906 that may generate the pattern. Pattern generator 906 may be implemented by one or more processors. In other aspects, projector 902 may receive the pattern from another source (e.g., via communication module 912).

In some aspects, projector 902 may include a camera 908 that may capture one or more images of an environment of projector 902. In some cases, projector 902 may be configured to scan the environment with camera 908. In other aspects, projector 902 may not include camera 908.

In some aspects, projector 902 may include an image analyzer 910 that may analyze images captured by camera 908. Image analyzer 910 may be implemented by one or more processors (e.g., the one or more processors that implemented pattern generator 906). Image analyzer 910 may analyze the images to determine whether the environment includes visually indistinct portions. In other aspects, projector 902 may not include image analyzer 910.

In some aspects, projector 902 may include a communication module 912 that may receive an indication of one or more visually indistinct portions of the environment. For example, a 6DoF system or a passive stereo-vision system may transmit an indication of one or more visually indistinct portions of the environment to projector 902 via communication module 912. In other aspects, projector 902 may not include communication module 912.

In cases in which image analyzer 910 determine a visually indistinct portion of the environment and/or in cases in which projector 902 received an indication of the visually indistinct portion of the environment via communication module 912, projector 902 may determine to project the pattern onto the visually indistinct portion. Additionally or alternatively, projector 902 may determine to adjust a projected pattern based on the determined visually indistinct portion and/or the visually indistinct portion indicated by the received indication.

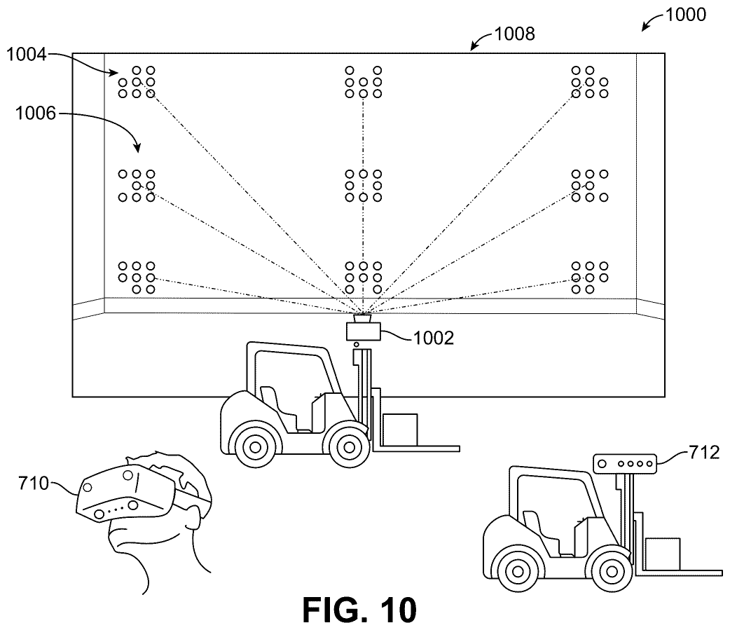

FIG. 10 is a diagram of an example environment 1000 in which systems and techniques may enable pose and/or distance determinations, according to various aspects of the present disclosure. For example, a projector 1002 may project a pattern 1004 into a scene 1008 (including onto a surface 1006 of scene 1008). A 6DoF system 710 may capture successive images of scene 1008 (including of pattern 1004 projected onto surface 1006) and may determine a pose of 6DoF system 710 based on the captured successive images. Additionally or alternatively, a passive stereo-vision system 712 may capture stereoscopically-paired images of scene 1008 (including pattern 1004 projected onto surface 1006) and may determine a distance between passive stereo-vision system 712 and points of surface 1006 based on the captured stereoscopically-paired images.

Projector 1002 of FIG. 10 may be the same as, may be substantially similar to, and/or may perform the same, or substantially the same, operations as projector 702 of FIG. 7. However, whereas projector 702 is described as being stationary relative to scene 708, projector 1002 may move, or be moved, relative to scene 1008. For example, projector 1002 may be positioned on a moving object (e.g., a robot or drone). Projector 1002 may be moved in environment 1000. Projector 1002 may project pattern 1004 onto surface 1006 despite 1002 moving. In some aspects, projector 1002 may project pattern 1004 such that pattern 1004 is constant with regard to surface 1006 despite projector 1002 moving within environment 1000.

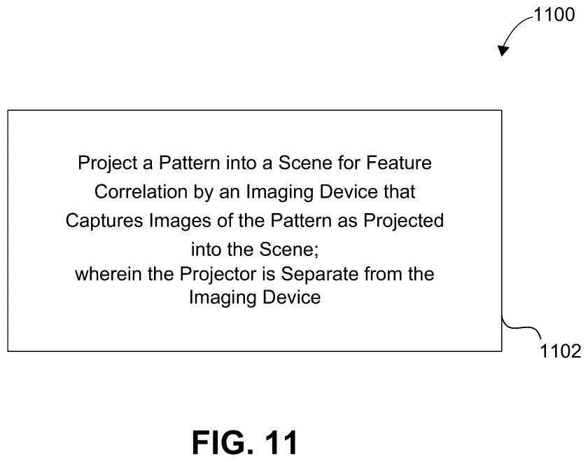

FIG. 11 is a flow diagram illustrating a process 1100 for enabling pose and/or distance determinations, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1100. The one or more operations of process 1100 may be implemented as software components that are executed and run on one or more processors.

At a block 1102, a computing device (or one or more components thereof) may cause a projector to project a pattern into a scene for feature correlation by an imaging device that captures images of the pattern as projected into the scene. The projector may be separate from the imaging device. For example, projector 702 may project pattern 704 into scene 708 for an imaging device (e.g., 6DoF system 710 or passive stereo-vision system 712) to perform feature correlation based on images of pattern 704 as projected into scene 708.

In some aspects, the imaging device may be configured to determine distances between the imaging device and points in the scene based on the images of the pattern as projected into the scene. For example, passive stereo-vision system 712 may be configured to determine distances between passive stereo-vision system 712 and points in scene 708 based on images captured by passive stereo-vision system 712 of pattern 704 as pattern 704 appears in scene 708.

In some aspects, the imaging device may be configured to determine distances between the imaging device and the points in the scene whether the projector projects the pattern or not. For example, the imaging device may be configured to determine distances between the imaging device and objects or surfaces of the scene even if the projector is not projecting the pattern into the scene. As another example, the imaging device may be configured to determine the distances even if the imaging device is capturing images of other portions of the scene, for example, portions that do not include the projected pattern. For example, passive stereo-vision system 712 may be configured to determine distances between passive stereo-vision system 712 and points in scene 708 whether projector 702 projects pattern 704 into scene 708 or not.

In some aspects, the imaging device may be configured to determine distances between the imaging device and the points in the scene without a priori information regarding the pattern. For example, passive stereo-vision system 712 may determine distances between passive stereo-vision system 712 and points in scene 708 without a priori information regarding pattern 704. For example, passive stereo-vision system 712 may match features of pattern 704, as projected into scene 708, between images captured by passive stereo-vision system 712 without passive stereo-vision system 712 having a priori information regarding pattern 704. For example, passive stereo-vision system 712 may not have information regarding pattern 704 (e.g., shape or pattern of pattern 704) or even information regarding whether pattern 704 is being projected into scene 708.

In some aspects, the imaging device may be, or may include, a passive stereo-vision system configured to correlate features of the pattern in stereoscopically-paired images of the scene to determine distances between the passive stereo-vision system and points in the scene. For example, the imaging device may be passive stereo-vision system 712 and passive stereo-vision system 712 may capture stereoscopically-paired images of scene 708 and correlate features between the stereoscopically paired images to determine distances between passive stereo-vision system 712 and points in scene 708.

In some aspects, the imaging device may be configured to determine a pose of the imaging device relative to the scene based on the images of the pattern as projected into the scene. For example, 6DoF system 710 may determine a pose of 6DoF system 710 relative to scene 708 based on image captured by 6DoF system 710 of pattern 704 as projected into scene 708.

In some aspects, the imaging device may be configured to determine the pose of the imaging device whether the projector projects the pattern or not. For example, the imaging device may be configured to determine a pose of the imaging device relative to the scene even if the projector is not projecting the pattern into the scene. As another example, the imaging device may be configured to determine the pose even if the imaging device is capturing images of other portions of the scene, for example, portions that do not include the projected pattern. For example, 6DoF system 710 may be configured to determine a pose of 6DoF system 710 whether projector 702 projects pattern 704 into scene 708 or not.

In some aspects, the imaging device may be configured to determine the pose of the imaging device without a priori information regarding the pattern. For example, 6DoF system 710 may determine a pose of 6DoF system 710 without a priori information regarding pattern 704. For example, 6DoF system 710 may match features of pattern 704, as projected into scene 708, between images captured by 6DoF system 710 without 6DoF system 710 having a priori information regarding pattern 704. For example, 6DoF system 710 may not have information regarding pattern 704 (e.g., shape or pattern of pattern 704) or even information regarding whether pattern 704 is being projected into scene 708.

In some aspects, the imaging device may be, or may include, a six-degree-of-freedom (6DoF) system configured to correlate features of the pattern in sequential images of the scene to determine a pose of the 6DoF system relative to the scene. For example, the imaging device may be 6DoF system 710 and 6DoF system 710 may be configured to capture sequential images of scene 708 and correlate features of pattern 704 as projected into scene 708 to determine a pose of 6DoF system 710 relative to scene 708.

In some aspects, the projector may project the pattern into the scene without receiving a communication from the imaging device. For example, projector 702 may project pattern 704 into scene 708 without receiving any communication (e.g., any instruction, request, etc.) from any of 6DoF system 6710 or passive stereo-vision system 712.

In some aspects, the projector may project the pattern into the scene whether the imaging device captures the images of the pattern as projected into the scene or not. For example, projector 702 may project pattern 704 into scene 708 whether 6DoF system 710 or passive stereo-vision system 712 captures images of scene 708 or not. Further, projector 702 may not have any information regarding whether 6DoF system 710 and/or passive stereo-vision system 712 are present in the environment of scene 708 or whether or not 6DoF system 710 and/or passive stereo-vision system 712 are capturing images of scene 708 or not.

In some aspects, the projector may project the pattern into the scene independent of the imaging device. For example, projector 702 may project pattern 704 into scene 708 independent of 6DoF system 710 and/or passive stereo-vision system 712. For example, projector 702 may project pattern 704 into scene 708 regardless of whether 6DoF system 710 and/or passive stereo-vision system 712 are present in an environment of projector 702, regardless of whether 6DoF system 710 and/or passive stereo-vision system 712 are operating in an environment of projector 702, regardless of whether 6DoF system 710 and/or passive stereo-vision system 712 are capturing images of scene 708, without any communication from 6DoF system 710 and/or passive stereo-vision system 712.

In some aspects, the projector may be movable relative to the imaging device. For example, the projector 702 may be moveable (and/or steerable) relative to 6DoF system 710 and/or passive stereo-vision system 712. For example, projector 702 may move (and/or reorient) separately from 6DoF system 710 and/or passive stereo-vision system 712. For example, projector 702 may independently moveable.

In some aspects, the projector may project the pattern into the scene at a first time, wherein the imaging device has a first pose relative to the projector at the first time; and project the pattern into the scene at a second time, wherein the imaging device has a second pose relative to the projector at the second time. For example, projector 702 may project pattern 704 at scene 708 at a first time. At the first time, 6DoF system 710 and/or passive stereo-vision system 712 may have a first pose relative to projector 702. Projector 702 may project pattern 704 at scene 708 at a second time. At the second time, 6DoF system 710 and/or passive stereo-vision system 712 may have a first pose relative to projector 702. For example, the pose of 6DoF system 710 and/or passive stereo-vision system 712 relative to projector 702 may change over time.

In some aspects, the projector may project the pattern such that the pattern is stationary relative to the scene. For example, projector 702 may project pattern 704 such that pattern 704 remains stationary relative to scene 708.

In some aspects, the projector may configured to be stationary relative to the scene and the imaging device may be configured to move relative to the scene. For example, projector 702 may be stationary relative to scene 708. For example, projector 702 may include legs and/or a stand or may be attachable to a wall or the ceiling. 6DoF system 710 and/or passive stereo-vision system 712 may be configured to be moved. for example, may be wearable or attachable to a moving system (e.g., a robot).

In some aspects, the projector may be configured to be moved relative to the scene separately from the imaging device. For example, projector 1002 may be configured to move relative to scene 1008. In such cases, the projector may project the pattern such that the pattern is stationary relative to the scene. For example, projector 1002 may project pattern 1004 such that pattern 1004 remains stationary relative to scene 708 despite 1002 moving relative to scene 1008.

In some aspects, the computing device (or one or more components thereof) may cause a camera to capture an image of the scene. The computing device (or one or more components thereof) may determine a visually indistinct portion of the scene based on the image; and cause the projector to project the pattern onto the visually indistinct portion of the scene. For example, camera 908 of projector 902 may capture an image of scene 708. Image analyzer 910 of projector 902 may analyze the image to determine a visually indistinct portion of scene 708. Projector 902 may project pattern 704 onto the visually indistinct portion of scene 708.

In some aspects, the computing device (or one or more components thereof) may cause a camera to capture an image of the scene. The computing device (or one or more components thereof) may analyze the pattern as projected into the scene as represented in the image of the scene, and cause the projector to, responsive to analyzing the pattern, adjust an intensity used to project the pattern; adjust a wavelength used to project the pattern; adjust a sparsity of dots of the pattern; adjust sizes of the dots of the pattern; and/or adjust shapes of the dots of the pattern. For example, camera 908 of projector 902 may capture an image of scene 708. Image analyzer 910 of projector 902 may analyze the image. Image analyzer 910 may determine how pattern 704, as projected into scene 708 appears. Projector 902 may adjust pattern 704 or how pattern 704 is projected into scene 708 bases on the analysis, for example, to make pattern 704 cause scene 708 to include more visually distinct portions or to make visually indistinct portions of scene 708 appear more visually distinct.

In some aspects, the computing device (or one or more components thereof) may generate the pattern. For example, projector 902 may include pattern generator 906 that may generates pattern 704. In some aspects, the projector may change the pattern. For example, pattern generator 906 of projector 902 may change pattern 704.

In some aspects, the pattern may encode information. For example, pattern 704 may encode information. In some aspects, the information may be, or may include, position information; time information; or a message. For example, pattern 704 may encode position information (e.g., relative to scene 708 and/or relative to a world coordinate system). As another example, pattern 704 may encode time information (e.g., a time of day and/or a date). As another example, pattern 704 may encode a message (e.g., an instruction or a warning).

In some aspects, the pattern may encode first information and the projector may be further configured to change the pattern to encode second information. For example, at a first time, projector 702 may project pattern 704 that encodes first information. Projector 702 may change pattern 704 to encode second information. Then, projector 702 may project the changed pattern 704 that encodes the second information.

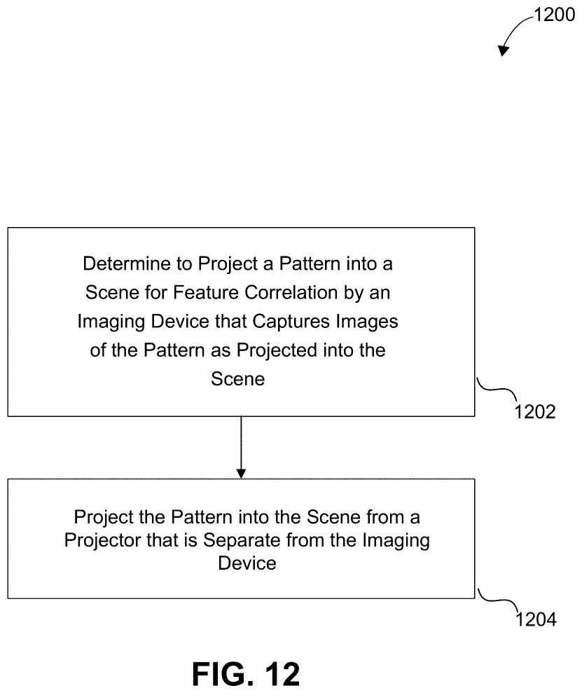

FIG. 12 is a flow diagram illustrating a process 1200 for enabling pose and/or distance determinations, in accordance with aspects of the present disclosure. One or more operations of process 1200 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1200. The one or more operations of process 1200 may be implemented as software components that are executed and run on one or more processors.

At a block 1202, a computing device (or one or more components thereof) may determine to project a pattern into a scene for feature correlation by an imaging device that captures images of the pattern as projected into the scene. For example, projector 702 may determine to project pattern 704 into scene 708 so that 6DoF system 710 and/or passive stereo-vision system 712 may capture images of pattern 704 in scene 708 and correlate features of pattern 704 in the images.

At a block 1204, the computing device (or one or more components thereof) may cause a projector to project the pattern into the scene. The projector may be separate from the imaging device. For example, projector 702 may project pattern 704 into scene 708. Projector 702 may be separate from 6DoF system 710 and/or passive stereo-vision system 712.

In some aspects, the computing device (or one or more components thereof) may cause a camera to capturing an image of the scene and determining a visually indistinct portion of the scene based on the image. Projecting the pattern into the scene may be, or may include, projecting the pattern at the visually indistinct portion of the scene. For example, camera 908 may capture an image of scene 708. Image analyzer 910 may determine a visually indistinct portion of scene 708. Projector 902 may project pattern 704 onto the visually indistinct portion of scene 708.

In some aspects, the computing device (or one or more components thereof) may cause a camera to capture an image of the scene. The computing device (or one or more components thereof) may analyze the pattern as projected into the scene as represented in the image of the scene, and cause the projector to, responsive to analyzing the pattern, adjust an intensity used to project the pattern; adjust a wavelength used to project the pattern; adjust a sparsity of dots of the pattern; adjust sizes of the dots of the pattern; and/or adjust shapes of the dots of the pattern. For example, camera 908 of projector 902 may capture an image of scene 708. Image analyzer 910 of projector 902 may analyze the image. Image analyzer 910 may determine how pattern 704, as projected into scene 708 appears. Projector 902 may adjust pattern 704 or how pattern 704 is projected into scene 708 bases on the analysis, for example, to make pattern 704 cause scene 708 to include more visually distinct portions or to make visually indistinct portions of scene 708 appear more visually distinct.

In some examples, as noted previously, the methods described herein (e.g., process 1100 of FIG. 11, process 1200 of FIG. 12, and/or other methods described herein) can be performed, in whole or in part, by a computing device or apparatus. In one example, one or more of the methods can be performed by projector 702 of FIG. 7 and/or FIG. 8, projector 902 of FIG. 9, projector 1002 of FIG. 10, or by another system or device. In another example, one or more of the methods (e.g., process 1100 of FIG. 11, process 1200 of FIG. 12, and/or other methods described herein) can be performed, in whole or in part, by the computing-device architecture 1300 shown in FIG. 13. For instance, a computing device with the computing-device architecture 1300 shown in FIG. 13 can include, or be included in, the components of the projector 702, projector 902, and/or projector 1002 and can implement the operations of process 1100, process 1200 and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, process 1200, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, process 1200 and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 13 illustrates an example computing-device architecture 1300 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1300 may include, implement, or be included in any or all of projector 702 of FIG. 7 and/or FIG. 8, projector 902 of FIG. 9, and/or projector 1002 of FIG. 10. Additionally or alternatively, computing-device architecture 1300 may be configured to perform process 1100, process 1200, and/or other process described herein.

The components of computing-device architecture 1300 are shown in electrical communication with each other using connection 1312, such as a bus. The example computing-device architecture 1300 includes a processing unit (CPU or processor) 1302 and computing device connection 1312 that couples various computing device components including computing device memory 1310, such as read only memory (ROM) 1308 and random-access memory (RAM) 1306, to processor 1302.

Computing-device architecture 1300 can include a cache of high-speed memory connected directly with, in close proximity to, or integrated as part of processor 1302. Computing-device architecture 1300 can copy data from memory 1310 and/or the storage device 1314 to cache 1304 for quick access by processor 1302. In this way, the cache can provide a performance boost that avoids processor 1302 delays while waiting for data. These and other modules can control or be configured to control processor 1302 to perform various actions. Other computing device memory 1310 may be available for use as well. Memory 1310 can include multiple different types of memory with different performance characteristics. Processor 1302 can include any general-purpose processor and a hardware or software service, such as service 1 1316, service 2 1318, and service 3 1320 stored in storage device 1314, configured to control processor 1302 as well as a special-purpose processor where software instructions are incorporated into the processor design. Processor 1302 may be a self-contained system, containing multiple cores or processors, a bus, memory controller, cache, etc. A multi-core processor may be symmetric or asymmetric.

To enable user interaction with the computing-device architecture 1300, input device 1322 can represent any number of input mechanisms, such as a microphone for speech, a touch-sensitive screen for gesture or graphical input, keyboard, mouse, motion input, speech and so forth. Output device 1324 can also be one or more of a number of output mechanisms known to those of skill in the art, such as a display, projector, television, speaker device, etc. In some instances, multimodal computing devices can enable a user to provide multiple types of input to communicate with computing-device architecture 1300. Communication interface 1326 can generally govern and manage the user input and computing device output. There is no restriction on operating on any particular hardware arrangement and therefore the basic features here may easily be substituted for improved hardware or firmware arrangements as they are developed.

Storage device 1314 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1306, read only memory (ROM) 1308, and hybrids thereof. Storage device 1314 can include services 1316, 1318, and 1320 for controlling processor 1302. Other hardware or software modules are contemplated. Storage device 1314 can be connected to the computing device connection 1312. In one aspect, a hardware module that performs a particular function can include the software component stored in a computer-readable medium in connection with the necessary hardware components, such as processor 1302, connection 1312, output device 1324, and so forth, to carry out the function.

The term “substantially.” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used here in, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A. B. and C” or “at least one of A, B, or C” means A, B, C, or A and B, or A and C, or B and C. A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X. Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus comprising: a projector configured to project a pattern into a scene for feature correlation by an imaging device that captures images of the pattern as projected into the scene; wherein the apparatus is separate from the imaging device.

Aspect 2. The apparatus of aspect 1, wherein the imaging device is configured to determine distances between the imaging device and points in the scene based on the images of the pattern as projected into the scene.

Aspect 3. The apparatus of any one of aspects 1 or 2, wherein the imaging device is configured to determine distances between the imaging device and the points in the scene whether the projector projects the pattern or not.

Aspect 4. The apparatus of any one of aspects 2 or 3, wherein the imaging device is configured to determine distances between the imaging device and the points in the scene without a priori information regarding the pattern.

Aspect 5. The apparatus of aspect 1, wherein the imaging device comprises a passive stereo-vision system configured to correlate features of the pattern in stereoscopically-paired images of the scene to determine distances between the passive stereo-vision system and points in the scene.

Aspect 6. The apparatus of aspect 1, wherein the imaging device is configured to determine a pose of the imaging device relative to the scene based on the images of the pattern as projected into the scene.

Aspect 7. The apparatus of aspect 6, wherein the imaging device is configured to determine the pose of the imaging device whether the projector projects the pattern or not.

Aspect 8. The apparatus of any one of aspects 6 or 7, wherein the imaging device is configured to determine the pose of the imaging device without a priori information regarding the pattern.

Aspect 9. The apparatus of aspect 1, wherein the imaging device comprises a six-degree-of-freedom (6DoF) system configured to correlate features of the pattern in sequential images of the scene to determine a pose of the 6DoF system relative to the scene.

Aspect 10. The apparatus of any one of aspects 1 to 9, wherein the projector is configured to project the pattern into the scene without receiving a communication from the imaging device.

Aspect 11. The apparatus of any one of aspects 1 to 10, wherein the projector is configured to project the pattern into the scene whether the imaging device captures the images of the pattern as projected into the scene or not.

Aspect 12. The apparatus of any one of aspects 1 to 11, wherein the projector is configured to project the pattern into the scene independent of the imaging device.

Aspect 13. The apparatus of any one of aspects 1 to 12, wherein the projector is movable relative to the imaging device.

Aspect 14. The apparatus of any one of aspects 1 to 13, wherein the projector is configured to: project the pattern into the scene at a first time, wherein the imaging device has a first pose relative to the projector at the first time; and project the pattern into the scene at a second time, wherein the imaging device has a second pose relative to the projector at the second time.

Aspect 15. The apparatus of any one of aspects 1 to 14, wherein the projector is configured to project the pattern such that the pattern is stationary relative to the scene.

Aspect 16. The apparatus of any one of aspects 1 to 15, wherein the projector is configured to be stationary relative to the scene and wherein the imaging device is configured to move relative to the scene.

Aspect 17. The apparatus of any one of aspects 1 to 16, wherein the projector is configured to be moved relative to the scene separately from the imaging de vice.

Aspect 18. The apparatus of any one of aspects 1 to 17, further comprising: a camera configured to capture an image of the scene; and at least one processor configured to: determine a visually indistinct portion of the scene based on the image; and cause the projector to project the pattern onto the visually indistinct portion of the scene.

Aspect 19. The apparatus of any one of aspects 1 to 18, further comprising: a camera configured to capture an image of the scene; and at least one processor configured to analyze the pattern as projected into the scene as represented in the image of the scene, wherein, responsive to analyzing the pattern, the projector is configured to at least one of: adjust an intensity used to project the pattern; adjust a wavelength used to project the pattern; adjust a sparsity of dots of the pattern; adjust sizes of the dots of the pattern; or adjust shapes of the dots of the pattern.

Aspect 20. The apparatus of any one of aspects 1 to 19, further comprising a pattern generator configured to generate the pattern.

Aspect 21. The apparatus of any one of aspects 1 to 20, wherein the pattern encodes information.

Aspect 22. The apparatus of aspect 21, wherein the information comprises at least one of: position information; time information; or a message.

Aspect 23. The apparatus of any one of aspects 1 to 22, wherein the projector is further configured to change the pattern.

Aspect 24. The apparatus of any one of aspects 1 to 23, wherein the pattern encodes first information and wherein the projector is further configured to change the pattern to encode second information.

Aspect 25. A method comprising: determining to project a pattern into a scene for feature correlation by an imaging device that captures images of the pattern as projected into the scene; and projecting the pattern into the scene from a projector that is separate from the imaging device.

Aspect 26. The method of aspect 25, further comprising: capturing an image of the scene; and determining a visually indistinct portion of the scene based on the image; wherein projecting the pattern into the scene comprises projecting the pattern at the visually indistinct portion of the scene.

Aspect 27. The method of any one of aspects 25 or 26, further comprising: capturing an image of the scene; analyzing the pattern as projected into the scene as represented in the image of the scene; and responsive to analyzing the pattern, at least one of: adjusting an intensity used to project the pattern; adjusting a wavelength used to project the pattern; adjusting a sparsity of dots of the pattern; adjusting sizes of the dots of the pattern; or adjusting shapes of the dots of the pattern.

Aspect 28. The method of any one of aspects 25 to 27, further comprising generating the pattern.

Aspect 29. The method of any one of aspects 25 to 28, wherein the pattern encodes information.

Aspect 30. The method of aspect 29, wherein the information comprises at least one of: position information; time information; or a message.

Aspect 31. The method of any one of aspects 25 to 30, further comprising changing the pattern.

Aspect 32. The method of any one of aspects 25 to 31, wherein the pattern encodes first information, and further comprising changing the pattern to encode second information.

Aspect 33. An imaging device comprising: two cameras configured to capture stereoscopically-paired images of a scene; and at least one processor configured to correlate features of the stereoscopically-paired images to determine distances between the two cameras and points in the scene corresponding to the features; wherein the points in the scene are illuminated by a pattern and wherein the pattern is projected by a projector that is separate from the imaging device.

Aspect 34. An imaging device comprising: a cameras configured to capture sequential images of a scene; and at least one processor configured to track features across the sequential images to determine a pose of the imaging device relative to the scene; wherein the features correspond to points in the scene that are illuminated by a pattern and wherein the pattern is projected by a projector that is separate from the imaging device.

Aspect 35. The apparatus of aspect 1, wherein the imaging device comprises a three-degree-of-freedom (3DoF) system configured to correlate features of the pattern in sequential images of the scene to determine a position of the 3DoF system relative to the scene.

What is claimed is:

1. An apparatus comprising:
a projector configured to project a pattern into a scene for feature correlation by an imaging device that captures images of the pattern as projected into the scene;
wherein the apparatus is separate from the imaging device.

2. The apparatus of claim 1, wherein the imaging device is configured to determine distances between the imaging device and points in the scene based on the images of the pattern as projected into the scene.

3. The apparatus of claim 2, wherein the imaging device is configured to determine distances between the imaging device and the points in the scene whether the projector projects the pattern or not.

4. The apparatus of claim 2, wherein the imaging device is configured to determine distances between the imaging device and the points in the scene without a priori information regarding the pattern.

5. The apparatus of claim 1, wherein the imaging device comprises a passive stereo-vision system configured to correlate features of the pattern in stereoscopically-paired images of the scene to determine distances between the passive stereo-vision system and points in the scene.

6. The apparatus of claim 1, wherein the imaging device is configured to determine a pose of the imaging device relative to the scene based on the images of the pattern as projected into the scene.

7. The apparatus of claim 6, wherein the imaging device is configured to determine the pose of the imaging device whether the projector projects the pattern or not.

8. The apparatus of claim 6, wherein the imaging device is configured to determine the pose of the imaging device without a priori information regarding the pattern.

9. The apparatus of claim 1, wherein the imaging device comprises a six-degree-of-freedom (6DoF) system configured to correlate features of the pattern in sequential images of the scene to determine a pose of the 6DoF system relative to the scene.

10. The apparatus of claim 1, wherein the projector is configured to project the pattern into the scene without receiving a communication from the imaging device.

11. The apparatus of claim 1, wherein the projector is configured to project the pattern into the scene whether the imaging device captures the images of the pattern as projected into the scene or not.

12. The apparatus of claim 1, wherein the projector is configured to project the pattern into the scene independent of the imaging device.

13. The apparatus of claim 1, wherein the projector is movable relative to the imaging device.

14. The apparatus of claim 1, wherein the projector is configured to:
project the pattern into the scene at a first time, wherein the imaging device has a first pose relative to the projector at the first time; and
project the pattern into the scene at a second time, wherein the imaging device has a second pose relative to the projector at the second time.

15. The apparatus of claim 1, wherein the projector is configured to project the pattern such that the pattern is stationary relative to the scene.

16. The apparatus of claim 1, wherein the projector is configured to be stationary relative to the scene and wherein the imaging device is configured to move relative to the scene.

17. The apparatus of claim 1, wherein the projector is configured to be moved relative to the scene separately from the imaging device.

18. The apparatus of claim 1, further comprising:
a camera configured to capture an image of the scene; and
at least one processor configured to:
determine a visually indistinct portion of the scene based on the image; and
cause the projector to project the pattern onto the visually indistinct portion of the scene.

19. The apparatus of claim 1, further comprising:
a camera configured to capture an image of the scene; and
at least one processor configured to analyze the pattern as projected into the scene as represented in the image of the scene,
wherein, responsive to analyzing the pattern, the projector is configured to at least one of:
adjust an intensity used to project the pattern;
adjust a wavelength used to project the pattern;
adjust a sparsity of dots of the pattern;
adjust sizes of the dots of the pattern; or
adjust shapes of the dots of the pattern.

20. The apparatus of claim 1, further comprising a pattern generator configured to generate the pattern.

21. The apparatus of claim 1, wherein the pattern encodes information.

22. The apparatus of claim 21, wherein the information comprises at least one of:
position information;
time information; or
a message.

23. The apparatus of claim 1, wherein the projector is further configured to change the pattern.

24. The apparatus of claim 1, wherein the pattern encodes first information and wherein the projector is further configured to change the pattern to encode second information.

25. A method comprising:
determining to project a pattern into a scene for feature correlation by an imaging device that captures images of the pattern as projected into the scene; and
projecting the pattern into the scene from a projector that is separate from the imaging device.

26. The method of claim 25, further comprising:
capturing an image of the scene; and
determining a visually indistinct portion of the scene based on the image;
wherein projecting the pattern into the scene comprises projecting the pattern at the visually indistinct portion of the scene.

27. The method of claim 25, further comprising:
capturing an image of the scene;
analyzing the pattern as projected into the scene as represented in the image of the scene; and
responsive to analyzing the pattern, at least one of:
adjusting an intensity used to project the pattern;
adjusting a wavelength used to project the pattern;
adjusting a sparsity of dots of the pattern;
adjusting sizes of the dots of the pattern; or
adjusting shapes of the dots of the pattern.

28. The method of claim 25, further comprising generating the pattern.

29. The method of claim 25, wherein the pattern encodes information.

30. The method of claim 29, wherein the information comprises at least one of:
position information;
time information; or
a message.
